(19) United States
(12) Patent Application Publication
(10) Pub. No.: US 2008/0062970 A1
(43) Pub. Date: Mar. 13, 2008

(54) INSTANT MESSAGE CALL CONNECT SYSTEM METHOD AND INTERFACE

(75) Inventors: Donald Picard, Cambridge, MA (US); Robert DeBenedictis, Cambridge, MA (US); Jose Capo, Pelham, NH (US); Ray Jimenez, Carlisle, MA (US)

Correspondence Address: STAAS & HALSEY LLP, SUITE 700, 1201 NEW YORK AVENUE, N.W., WASHINGTON, DC, 20005, US

(73) Assignee: Common Voices, Boston, MA (US)

(21) Appl. No.: 11/853,642

(22) Filed: Sep. 11, 2007

Related U.S. Application Data
(60) Provisional application No. 60/825,171, filed on Sep. 11, 2006.

(51) Int. Cl. H04M 3/42; H04L 12/56; H04M 3/533; H04L 12/66

(52) U.S. Cl. 370/352; 379/201.01; 379/88.13; 379/88.19; 455/415

(57) ABSTRACT

A system that allows a computer user to designate a cellular telephone buddy to whom to send a text message asking the cellular telephone buddy to call the user back. The buddy calls the user by having the cellular telephone automatically place a call back telephone call to the user at the computer. The call is routed to the user at the user's computer via voice over internet protocol (VoIP) communications

### CROSS-REFERENCE TO RELATED APPLICATION

This application is related to U.S. provisional application entitled Instant Message Call Connect System having Ser. No. 60/825,171 by Picard, et al, filed Sep. 11, 2006 and incorporated by reference herein. This application is also related to concurrently filed U.S. application entitled “Instant Message Call Connect System Apparatus and Database” having Ser. No. ______ by Picard, et al, also incorporated by reference herein.

### REFERENCE TO COMPUTER PROGRAM LISTING APPENDIX

A computer program listing Appendix is attached hereto and incorporated by reference herein.

### BACKGROUND

1. Field

The embodiments discussed herein are directed to an instant message call connect system.

2. Description of the Related Art

There is a need to allowing a user at a computer to initiate a telephone call with another individual using an instant messaging communication system that also allows the internet service provider to avoid paying per minute charges whenever someone at a computer wants to make a telephone call

### SUMMARY

It is an aspect of the embodiments discussed herein to provide a system that will allow a user at a computer to select a buddy to return a telephone call to the user at the computer from a cellular telephone.

The above aspects can be attained by a system that allows a computer user to designate a cellular telephone buddy to whom to send a text message asking the cellular telephone buddy to call the user back. The buddy calls the user by having the cellular telephone automatically place a call back telephone call. The call is routed to the user at the user's computer using voice over internet protocol (VoIP) communications.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 depicts hardware of an embodiment.

FIG. 2 shows the flow for sending an SMS text message.

FIGS. 3 and 4 show call flow.

FIGS. 5-14 depict a database.

FIG. 15 depicts an interface.

### DETAILED DESCRIPTION OF THE EMBODIMENTS

Described herein are embodiments of a system allowing a user to initiate a telephone call with another individual using an instant messaging communication system. The system allows a user to sign up (and sign-on) without requiring a pass code and still have access to the call connection features. Other pass code protected features can be included, but the base features can be used by anyone (thus allowing for easy sign up). The system allows the user the to send a text message to a “buddy's” cell phone right from the website, and the text message will include the callAbuddy (cAb) personal phone number for the user, this allows the system to offer a free service that does not have any fee/minute charges to the system as a service provider. The message send to the buddy's cell telephone can be a multimedia message that includes an image, text and audio or a combination. While there are other services in the market (Skype Out, AIM digits), and they allow for “free” calling, the service provider (Skype, AOL) is paying per minute charges whenever they are letting someone call out using the service. The system avoids this problem by the initiator sending a text message (which is free to the system as a service provider) and then having the mobile phone user call the initiator back, so the system does not have to pay any per minute charges. In addition the system can use the instant messaging channel in combination with the audio channel for advertising, and provide links in the IM channel that correspond to the audio ads in the audio channel. Further, “hotword” detection can be used during the real time voice call to give context sensitive ads. The callAbuddy (cAb) service can also associate a callback number with a call routing application (which then may invoke calling a callAbuddy user). This allows a popular restaurant, for example, to send out a Short Message Service (SMS) message to a group of diners that are interested in finding out about a cancellation, and allow the recipient of the broadcast SMS to call the restaurant back simply by pressing the send key on their phone (since the cAb telephone number will be the callback number for the SMS).

Prior to the discussion of the operations of the embodiments of the subject matter discussed herein, a discussion of the hardware used in the system will be provided.

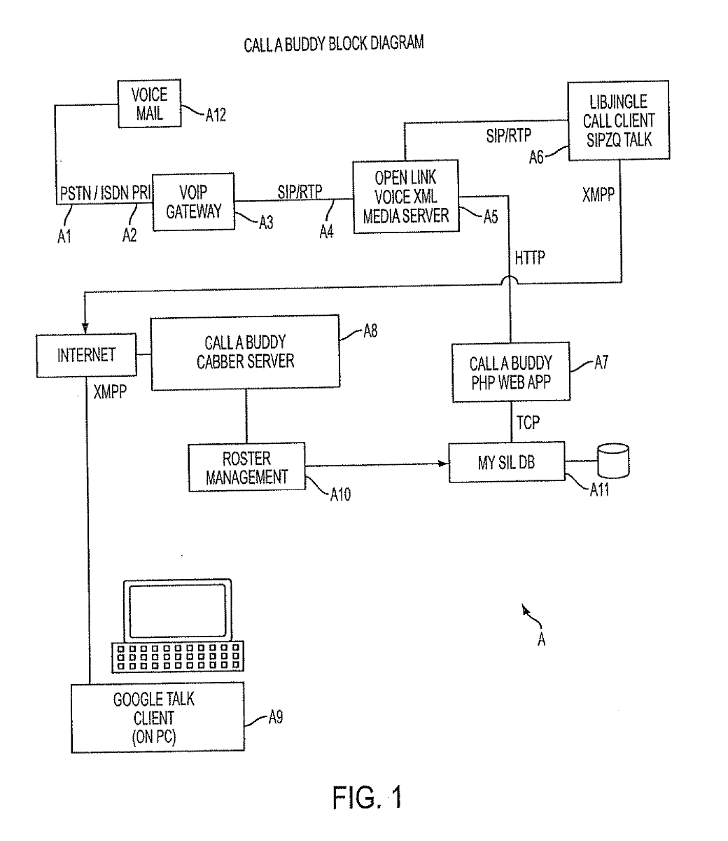

In FIG. 1, the callAbuddy (cAb) system A includes communication network, such as a Public Switched Telephone Network (PSTN) A1 or VoIP (Voice over IP) network, that communicates via an Integrated Services Digital Network, Primary Rate Interface (ISDN PRI) A2 with a VoIP Gateway (A3), such as a Cisco AS53xx series gateway, or similar device, which translates from circuit-switched (TDM) signaling to VoIP (SIP/RTP) Signaling. A Session Initiation Protocol/Real Time Protocol (SIP/RTP) A4 is used for Voice over IP calls to communicate with an OpenLink VoiceXML Media Server A5. The OpenLink server A5 is a software based media server, manufactured by and available from Common Voices of Boston, Mass. The software runs on standard Intel/AMD (HP, Sun, Dell, etc.) hardware that runs RedHat Enterprise Linux 4.2. A libjingle call client (sip2gtalk) A6 translates for SIP/RTP to XMPP through the libjingle client code provided by Google®. libjingle is freely available from talk.google.com. A callAbuddy PHP web application A7 is group of PHP scripts that run under Apache 2.0 on Linux. The callAbuddy web application outputs VoiceXML markup to the OpenLink VoiceXML media server for call handling, and HTML to any standard web browser for registration, login, and SMS (text messaging) functions. A callAbuddy jabber server A8 is an XMPP server that waits for XMPP events from the jabber network. The jabber server is currently implemented with ejabber 2.0, which is available from http://ejabberd.jabber.ru. and is a free and open source instant messaging server written in Erlang. The jabber server federates with the Google Talk jabber network in order to receive XMPP events from Google Talk users. A9 indicates a standard Google Talk client available from talk.google.com and running on a computer, such as a personal computer or another type of computer. The computer A9 is connected to a packet switched network, such as the Internet or an infranet. The user of the Google Talk client must be registered with the callAbuddy service, and needs to also accept pal@callabuddy.com as his/her friend in order for the callAbuddy service to receive availability updates as well as present calls to the Google Talk user. A roster manager A10 is an XMPP client which authenticates as pal@callabuddy.com and responds to invitation requests as well as presents Google Talk messages to a user that is about to receive an incoming VoIP call. The roster manager is C++ code that is implemented with the gloox library, which is freely available from http://camaya.net/gloox and is a full-featured Jabber/XMPP client library, written in C++. A callAbuddy service (MySQL DB) A11 stores information in various SQL tables, described elsewhere in this application. MySQL is available with Redhat Enterprise Linux 4.2 as an optional package. It is also available from www.mysql.com. A voice mail server A12 is provided to store messages when the user is online or does not accept a call.

The computer A9 can be a handheld device such as personal digital assistant (PDA), the computer of another hand held device, a computer running a computer assisted telephone application, such as an automated attendant, a computer reservation system for a restaurant or an airline, an automated service announcement system, etc.

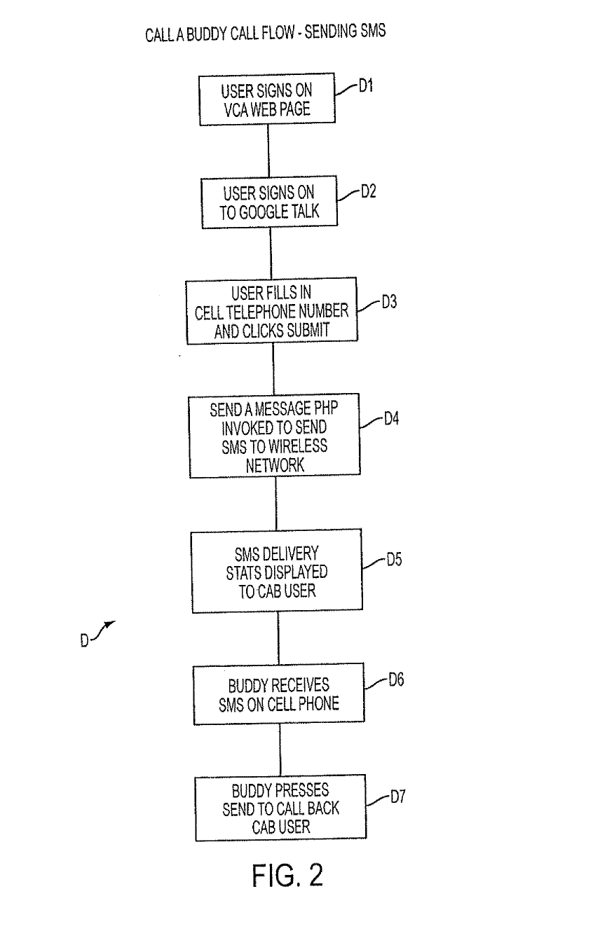

A user conventionally registers with the callAbuddy (cAb) system A. After a callAbuddy (cAb) user has completed the registration process and received their callAbuddy telephone number (DID), as depicted in FIG. 2, the callAbuddy user signs into D1 their callAbuddy account with their Google Talk ID and (optional) password at callabuddy.com. The sign-on application is implemented in the callAbuddy PHP Web Application (A7). The callAbuddy PHP Web Application A7 examines the gtalkStatus of an accounts table in the database to determine if the callAbuddy user is available through their Google Talk client, and displays this information to the cAb user as a reminder to sign in to Google Talk in order to receive a call. Furthermore, the callAbuddy PHP Web Application A7 displays the SMS Text Entry input form if the cAb user is Available for a call. The callAbuddy user then signs into D2 Google Talk using their Google Talk Client A9 on their multimedia capable personal computer. The cAb user reflects their status as Available using the Google Talk client, and their status is reflected in the callAbuddy PHP Web Application A7 after an automatic screen refresh.

The callAbuddy PHP Web Application A7 presents D3 the SMS Text Entry form to the callAbuddy (cAb) user through their web browser. The user inputs the 10 digit cellular telephone number of the buddy to which they wish to speak. The user may also choose to personalize the text message that is part of the SMS Text Entry form, or may accept the default text message. The cAb user clicks on “Submit”.

Next, a sendamessage.php script is invoked D4 to send the text message to the supplied cellular telephone number. The sendamessage.php script examines a cellToCarrierMap table to determine if this cellular number has been attempted previously, and if so, what wireless carrier to use. The sendamessage.php script constructs a text message customized to the particular wireless carrier that is being attempted. The script sets the callback number of the SMS text message to the direct inward dialing (DID) number of the callAbuddy (cAb) user, and also sets the text message to be the message chosen by the cAb user in operation D3. The sendamessage.php script then sends the message to the wireless carrier and updates a currentSmsStatus table in the database. After receiving the final status from the wireless carrier network (SUCCESS or FAILURE), the sendamessage.php script completes.

The callAbuddy PHP Web Application A7 periodically checks D5 the status in the currentSmsStatus table to see if it is SUCCESS or FAILURE, so that the cAb user will know when the message was sent.

The wireless network delivers D6 the text message to the cellular phone of the buddy, and the buddy is notified of the incoming text message on his phone in the typical conventional manner.

The buddy presses D7 the Send key on their wireless phone to begin a telephone call with the callback number associated with the SMS text message. The callback number was set to the cAb user's telephone number by sendamessage.php when it constructed the outbound SMS text message in step D4. The telephone call is presented to the callAbuddy (cAb) service through the PSTN network A1.

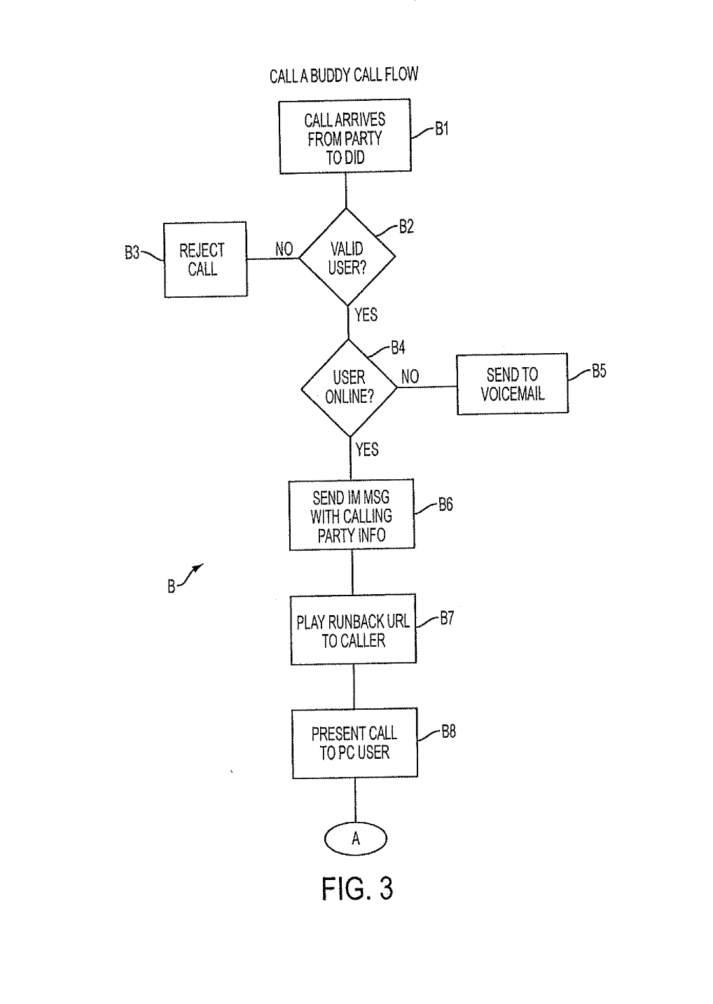

As depicted in FIG. 3, the buddy call arrives B1 from the PSTN over the VoIP Gateway A3. The VoIP Gateway A3 presents the call to the VoiceXML Media Server A5 over SIP/RTP (A4). The VoiceXML media server is configured to invoke the callAbuddy application A7 and passes in the Telephone Number of the called party (DID), the calling party number, and the calling party name (if provided by the PSTN).

The callAbuddy application retrieves B2 the account record from the accounts table for this particular DID. If no record is found, then this is not a call for a registered user, in which case the callAbuddy application rejects the call, B3.

If there is a valid account record, the callAbuddy application A7 examines B4 the gtalkStatus field to see if the cAb user is available for taking a call. It also examines the call Status field to see if the cAb user is already on another call.

If the callAbuddy (cAb) user is either not available, or if the cAb user is already on another call, then the callAbuddy application A7 constructs B5 a VoiceXML transfer to the vmailUrl associated with the personalInfo for the subscriber so that subscriber specific call handling proceeds, such as taking a message for the cAb user and storing it in the users voice mail box. If the cAb user is available, then the callAbuddy application A7 retrieves an available channel from a channels table, and marks the channel as inUse.

If the user is online, the callAbuddy application instructs B6 the rosterManager A10 to send an instant message (IM) to the Google Talk Client A9 where the cAb user is online. The IM contains the calling party number and (optionally) the name of the buddy who is calling.

The callAbuddy application A7 then instructs B7 the VoiceXML media server to transfer the call to the channel chosen at the end of step B5. The callAbuddy application also includes the ringbackUrl from a personalInfo table for the subscriber so that the outside caller will hear the chosen ringback tone while the call is being routed to the Google Talk Client A9.

The sip2gtalk libjingle call client A6 then presents B8 the call via XMPP to the PC user through the Google Talk client A9.

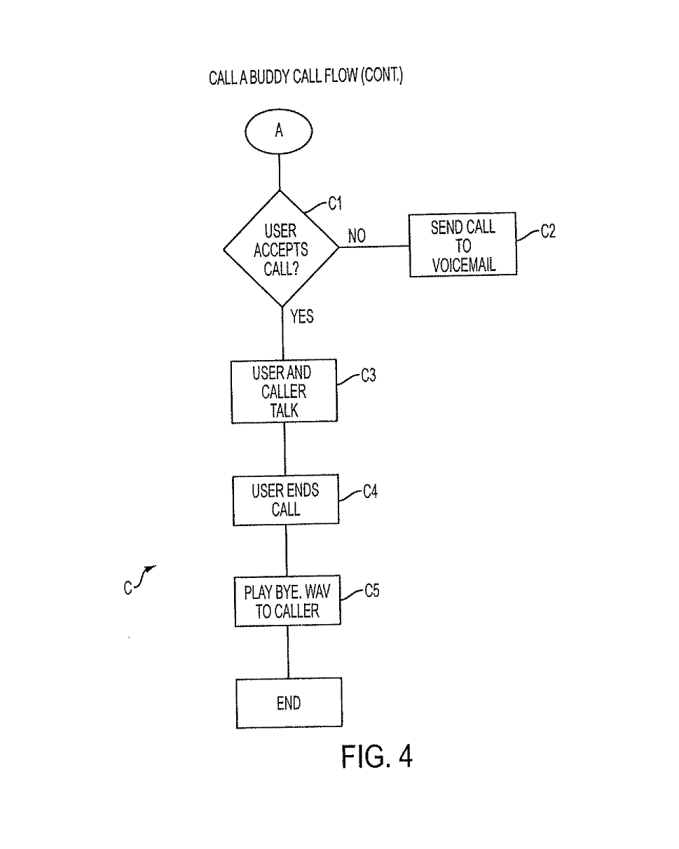

The Google Talk client presents C1 a popup window to the PC user to either Accept or Reject the call, as depicted in the flow of FIG. 4.

If the PC user decides C2 to Reject the call, or does not Accept the call within a predetermined amount of time, the callAbuddy application A7 instructs the VoiceXML media server to transfer the call to the configured vmailUrl, in the same manner as in step B5.

If the PC user accepts the call, then a real time voice conversation is established C3 between the Google Talk client and the PSTN caller through XMPP and SIP/RTP (A4).

Eventually the call completes or ends, and the cAb user ends the call C4 through the Google Talk client.

The callAbuddy application A7 then instructs C5 the VoiceXML media server to play the terminatingAdUrl that is retrieved from the personalInfo table to the outside caller. Finally, the callAbuddy application A7 updates a call History table with the information gathered from the call.

Below is provided a description of the database and data structures (tables) that are used in the callAbuddy (cAb) application code. The figures show phpMyAdmin screens, which is a popular browser based tool for managing MySQL databases.

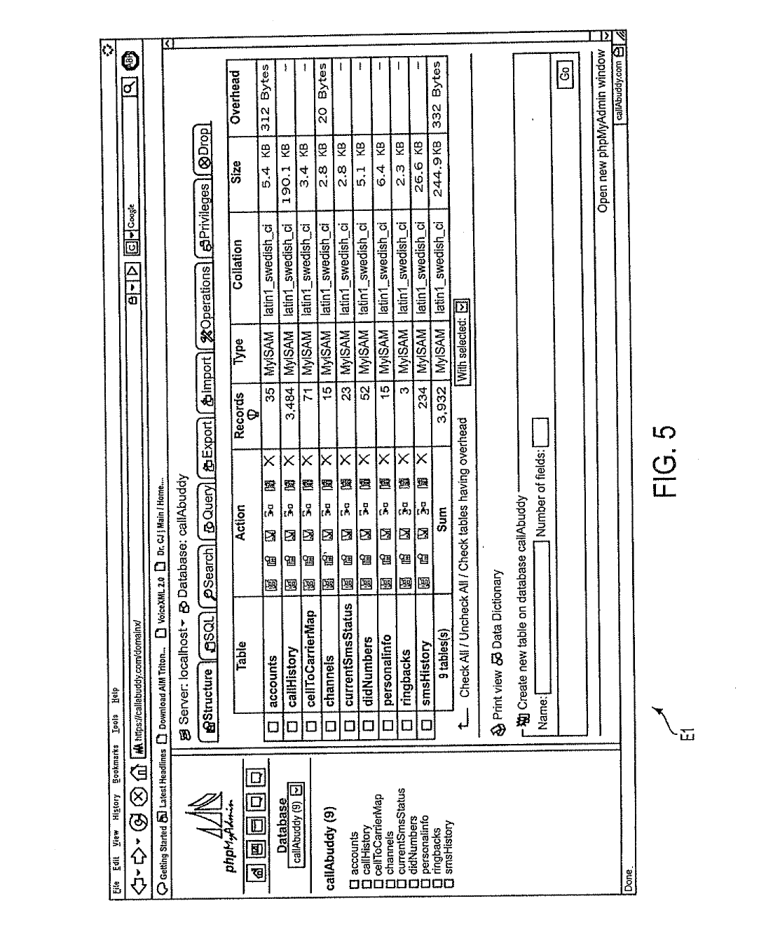

The FIG. 5 illustrates the callAbuddy database E1. The database includes 9 tables, namely: accounts, callHistory, cellToCarrierMap, channels, currentSmsStatus, didNumbers, personalInfo, ringbacks, and smsHistory. Each table is described in greater detail below.

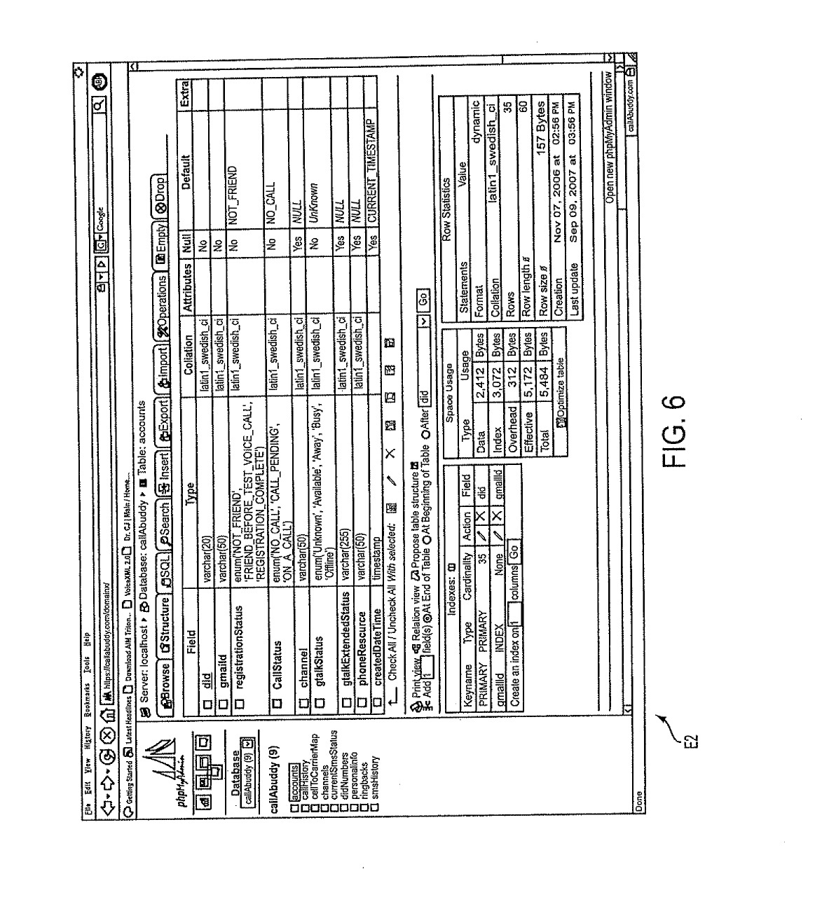

The accounts table E2 (FIG. 6) includes 9 fields, namely: did, gmailId, registrationStatus, callStatus, channel, gtalkStatus, gtalkExtendedStatus, phoneResource, and createDateTime. The field “did” is a common field in many tables. It represents the telephone number associated with the callAbuddy user, and represents a mapping between the phone number and the gmailId. The field “gmailId” is their Google® Mail identifier (typically something like dpicard@gmail.com). The gmailId is a primary index for the accounts table, since it represents the identification of the user on their personal computer. The field “registrationStatus” is an enumeration, and reflects the current status of the registration for this callAbuddy user. The field “callStatus” reflects the status of any active call for this user, since the system currently supports a single call to the PC user at a time. The field “channel” reflects what VoIP channel (IP address and port number) the user is currently associated with if the callStatus is either “CALL_PENDING” or “ON_A_CALL”. The field “gtalkStatus” is an enumeration of the current Google Talk status from the PC client software, and is primarily used to know how to route any incoming call to the DID. The field “gtalkExtendedStatus” contains any user supplied text from the PC client as to why their gtalkStatus is set to the current value (e.g. if the PC user is Busy, and wants to indicate that they will be available in an hour, the extended status is used to contain this text from the user.) The field “phoneResource” is used to indicate which gmail login instance is available to take a voice call. Gmail users may be logged in over multiple devices and/or interfaces, not all of which are capable of accepting a voice call. The field “createDateTime” is used to store the date and time that the account was created for auditing purposes.

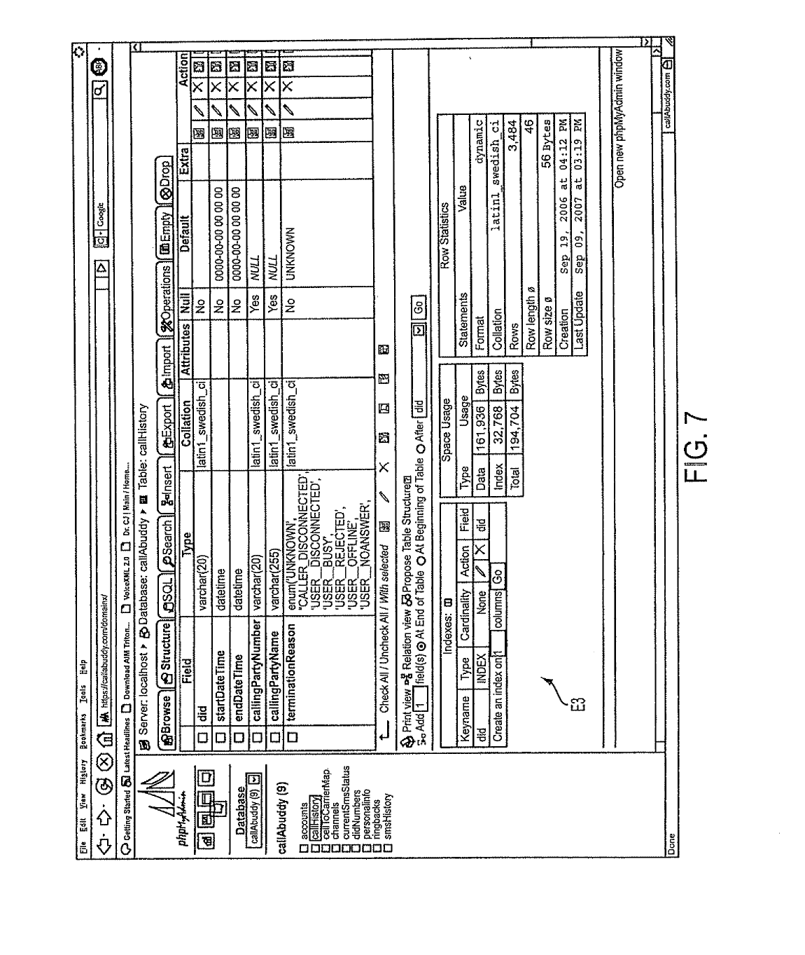

The callHistory table E3 (FIG. 7) includes 5 fields, namely: did, startDateTime, endDateTime, callingPartyNumber, callingPartyName, terminationReason. This table maintains the call log of any calls that arrived on the callAbuddy did. The did field is the telephone number that was called. The startDateTime field is the date and time the call began. The endDateTime field is the date and time that the call completed. The callingPartyNumber is any caller ID telephone number information that arrived from the PSTN. The callingPartyName is any caller ID name that arrived from the PSTN. The terminationReason is an enumeration as to why the call was disconnected.

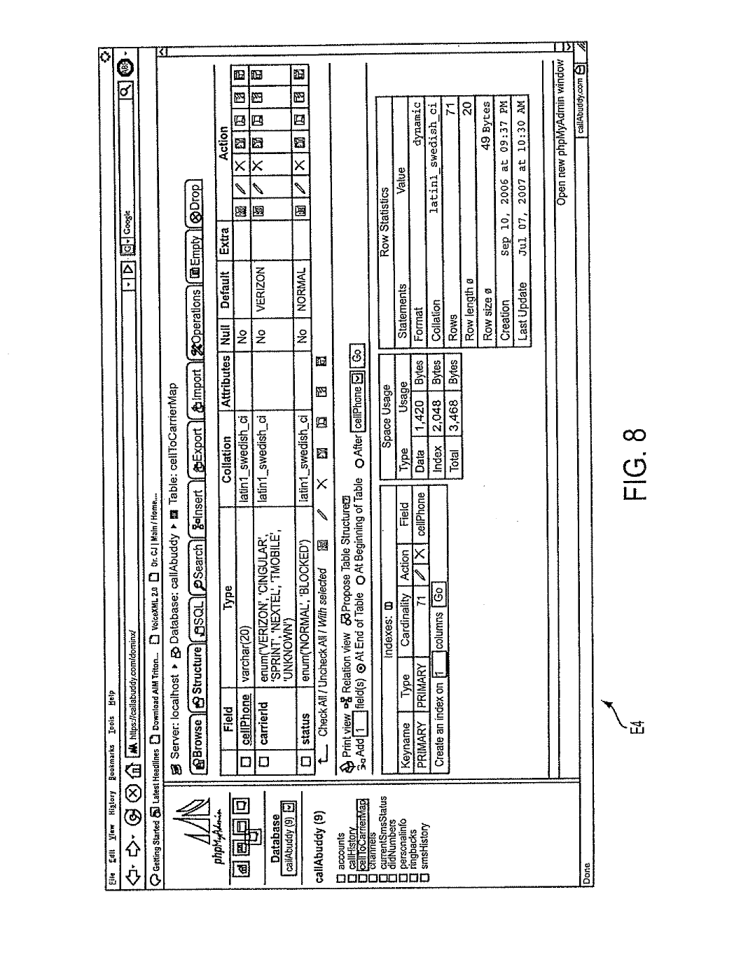

The cellToCarrierMap table E4 (FIG. 8) is used to cache information as to what wireless carrier network a particular cellPhone number is associated with, so that SMS messages for a phone number can be routed efficiently. It includes the following 3 fields: cellPhone, carrierId, status. The “cellPhone” field is the number for the cellPhone that will receive an SMS. The “carrierId” is an enumeration of the wireless carriers that callAbuddy supports, and is the particular wireless carrier that the given phone number is currently associated with. The “status” field is an enumeration, and indicates whether a particular cellPhone user has requested whether or not to receive SMS notifications from the callAbuddy service.

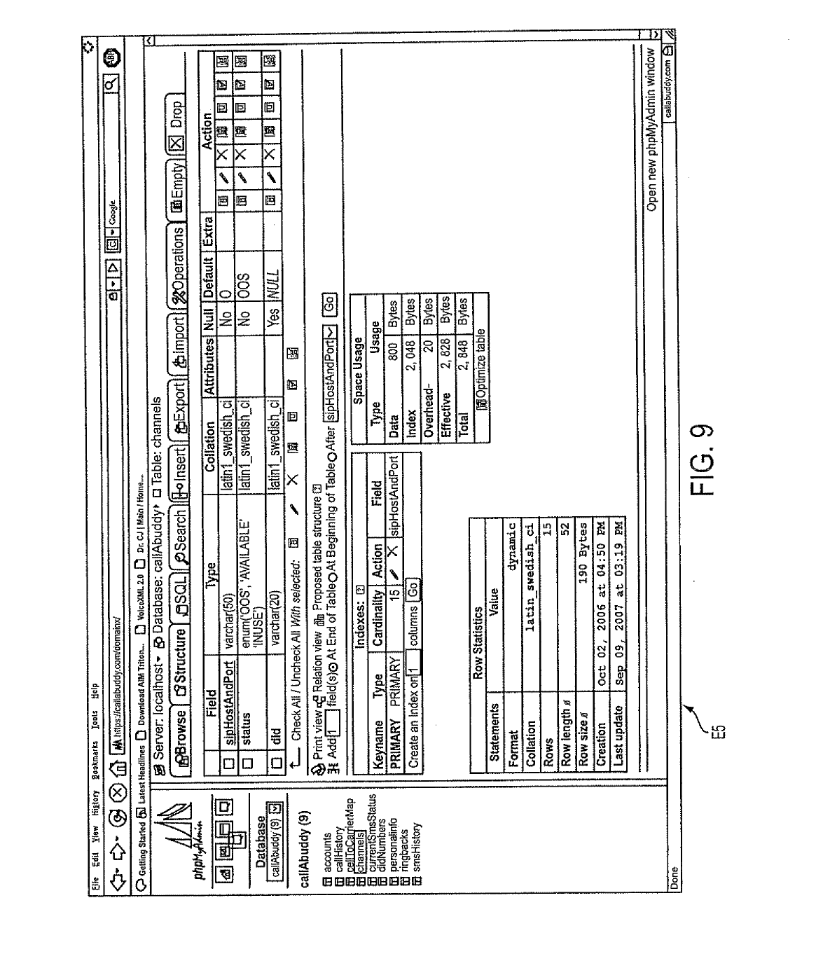

The channels table E5 (FIG. 9) is a list of the current VoIP channels that are ready to service a call from a DID to a callAbuddy user on their personal computer. When a call arrives for a callAbuddy user, and they are Available and ready to take a call on their PC, the channels table is consulted to find an available channel over which to route the call. It includes three fields, namely: sipHostAndPort, status, and did. The sipHostAndPort field indicates the host name or IP address of the VoIP endpoint that is ready to take the call, as well as the UDP port number of the endpoint on the given host name or IP address. The host name or IP address is separated from the UDP port number by a colon character (e.g. voipgateway1.callabuddy.com:5060). The status field is an enumeration and indicates whether the channel is OOS (out of service), AVAILABLE, or INUSE. The did field is the telephone number of the callAbuddy user on a call on this channel (if the status is set to INUSE).

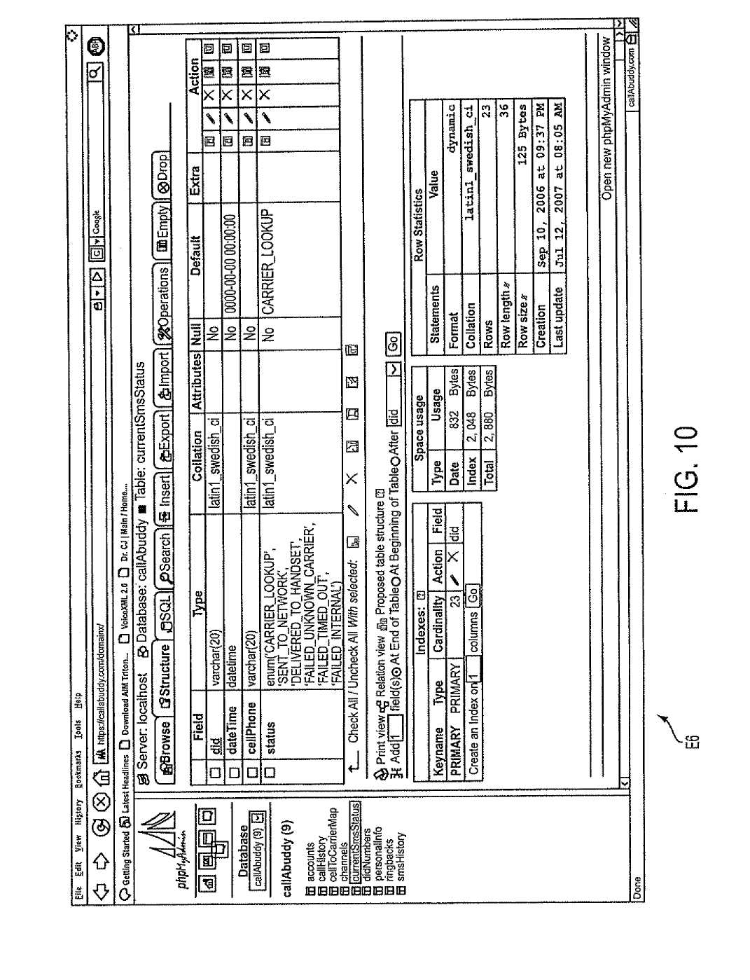

The currentSmsStatus table E6 (FIG. 10) includes 4 fields, namely: did, dateTime, cellPhone, and status. This table is used to indicate any currently outgoing SMS on behalf of a callAbuddy user. The did is the telephone number for this callAbuddy user. The dateTime is the date and time that the SMS was requested to be sent. The cellPhone is the cellular phone number that the callAbuddy user requested to be notified. The status is an enumeration and reflects the current status of the SMS.

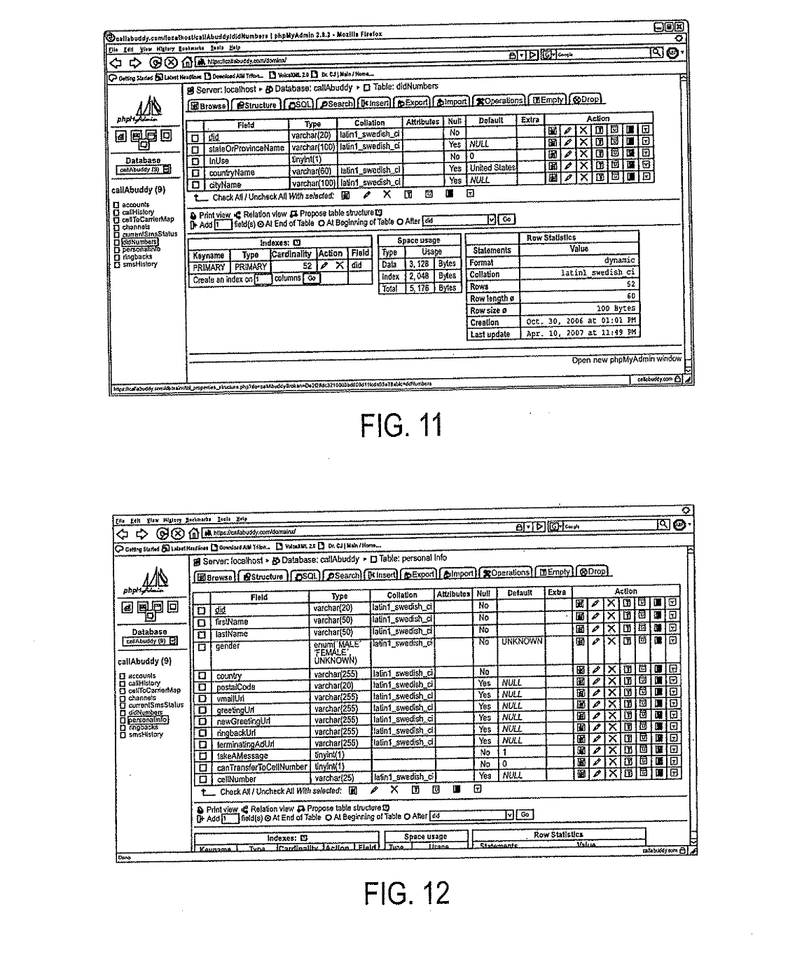

The didNumbers table E7 (FIG. 11) is a listing of the various telephone numbers that are part of the callAbuddy network. It includes 5 fields, namely: did, stateOrProvinceName, inUse, countryName, cityName. The did field is the telephone number. The stateOrProvinceName field is the state or province where the telephone number is located geographically. The inUse field is a Boolean indication as to whether or not this particular DID is in use. The countryName field is the country where the telephone number is located geographically. The cityName field is the city where the telephone number is located geographically.

The personalInfo table E8 (FIG. 12) contains user definable and/or configurable attributes of their callAbuddy account. It includes 4 fields, namely: did, firstName, lastName, gender, country, postalCode, vmailUrl, greetingUrl, newGreetingUrl, ringbackUrl, terminatingAdUrl, takeAMessage, canTransferToCellNumber, cellNumber. The did field is the telephone number for this callAbuddy user. The firstName field is the text of the first name of the callAbuddy user. The lastName field is the text of the last name of the callAbuddy user. The gender field is the gender (if known) of the callAbuddy user. The country field is the country for where the callAbuddy user typically resides. The postalCode field is the postal code for where the callAbuddy user typically resides. The vmailUrl field is the voice mail URL for the VoiceXML based voice mail platform that will accept the call if the callAbuddy user is either offline or has rejected the call. The greetingUrl field is the URL of the wave file to play for this callAbuddy user. The newGreetingUrl field is the URL for the newly recorded wave file to play for this callAbuddy user. The ringbackUrl field is the URL for the wave file to play to the caller while they wait for the call to be routed to the callAbuddy user. The termatingAdUrl field is the URL for the wave file to play to the caller when the call has completed. The takeAMessage field is a Boolean indication of whether the callAbuddy user wants the call to be handled directly by the voice messaging platform defined in the vmailUrl field. The canTransferToCellNumber field is a Boolean indication as to whether or not this callAbuddy user is permitted to transfer calls to another number (typically a cell phone) when the user is offline. The cellNumber is the telephone number (typically a cell phone) that the user has indicated that they want to receive a callAbuddy call when they are offline from callAbuddy. This field is only consulted if the canTransferToCellNumber field has the value “true”.

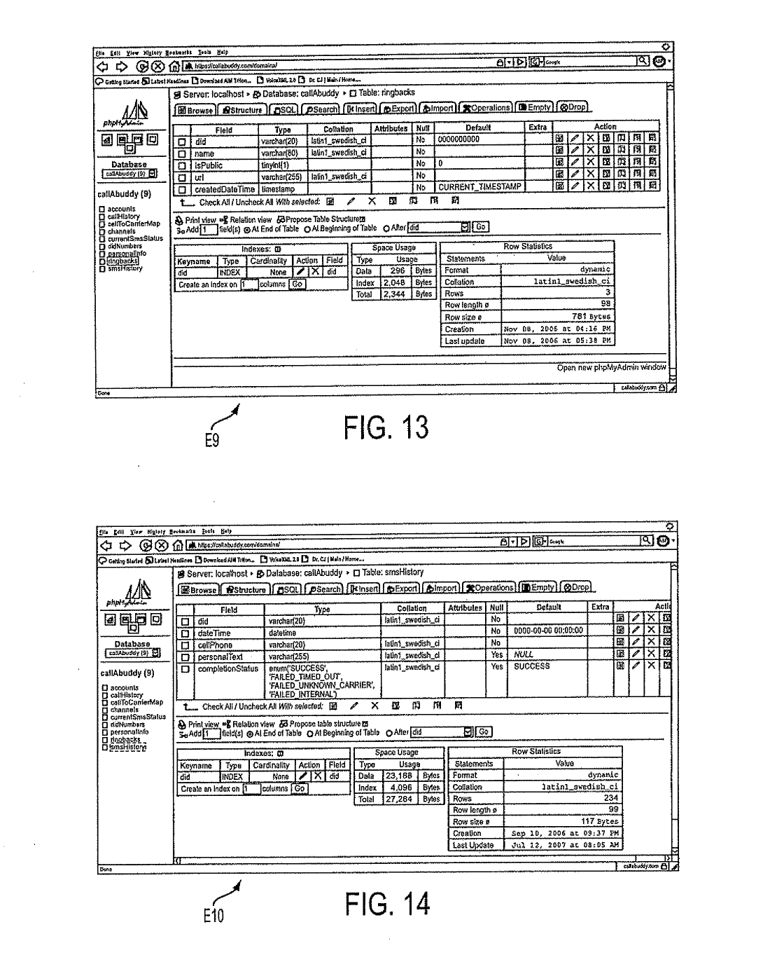

The ringbacks table E9 (FIG. 13) is used to define end-user supplied ringback tones (wav files). It includes 5 fields, namely: did, name, isPublic, url, createdDateTime. The did field is the telephone number of the callAbuddy user. The name field is the text name that the callAbuddy user has given to this particular ringback tone (e.g. “dog barking”). The isPublic field is a Boolean indication as to whether or not this particular ringback tone can be made available to other callAbuddy users. The url field is the URL of the wav file that was uploaded by the callAbuddy user. The createdDateTime field is the date and time that this particular ringback tone was uploaded by the callAbuddy user.

The smsHistory table E10 (FIG. 14) is used to store any of the SMS (text messages) that have been sent on behalf of a callAbuddy user. It includes 5 fields, namely: did, dateTime, cellPhone, personalText, and completionStatus. The did field is the telephone number of the callAbuddy user. The dateTime field is the date and time that the callAbuddy user originally requested that this SMS be sent. The cellPhone field is the telephone number of the cellular phone that the callAbuddy user requested to receive this SMS message. The personalText field is the text of the SMS message that the callAbuddy user requested to be sent. The completionStatus field is and enumeration and indicates the status of the final status of the SMS message.

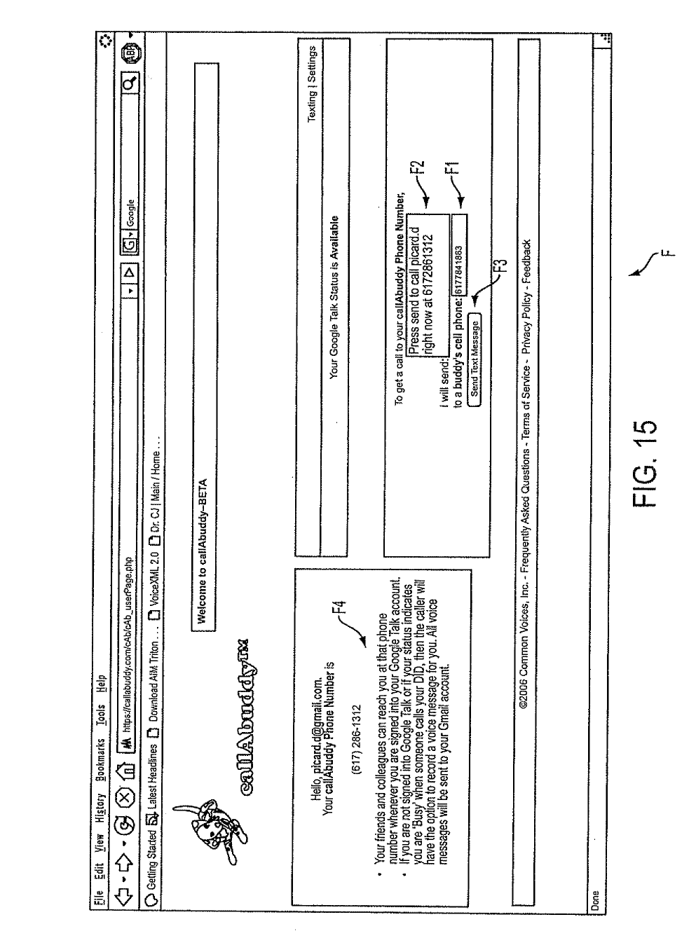

FIG. 15 depicts a graphical user interface F that the user uses to specify the cellular telephone number of the buddy. The interface includes a field F1 for the buddy telephone number, a field F2 for a text message to be sent to the cellular telephone of the buddy and a control or button F3 send the message to the buddy number. The interface also shows the callAbuddy (cAb) system telephone number F4 of the user.

The callAbuddy (cAb) application discussed above allows the cAb user to associate a telephone number with their account. This telephone number is typically used to route a call to their cAb DID to the cAb user if they are not online (not signed in to Google Talk). Another use for the telephone number is to allow the cAb user to call their own cAb DID. The cAb web application A7 can treat the call differently than the call from a buddy, since the telephone number of the caller is registered with the cAb user. The cAb web application A7 could then, through telephony prompts, allow the cAb user to input through DTMF or speech recognition the telephone number of a buddy they wish to contact. This would allow the cAb user to originate cAb calls without having to be online. One advantage of this approach is that the cAb user would not have to share his/her telephone number with a buddy—thus permitting the cAb user to maintain their anonymity.

Attached hereto is a computer program listing Appendix incorporated by reference herein and including a code listing where the web pages are in PHP (a popular web programming language) and PHP generates either VoiceXML (vxml, for telephony call flow) or HTML (for web pages viewed in a standard browser), where some modules are in C++ code, particularly the rosterManager and sip2gtalk modules and some modules are in Perl code and Unix shell scripts that are part of the Utils area (for controlling things like starting/stopping different components, and interface with the MySQL database) and the code can provide the functionality discussed herein. The code operates with a number of packages that are readily available for download from the Internet, including: ejabberd-1.1.1_{—}2-linux-installer.bin; erlang-R11B-0.1.fc3.i386.rpm; gloox-0.8.1-sic.tar; iksemel-1.2.tar.gz; ilbc-rfc3951.tar.gz; notlame-3.96.1-1.i686.rpm; ortp-0.7.1.tar.gz; phpMyAdmin-2.8.2.tar; and Proc-ProcessTable-0.41.tar.gz The Appendix also includes image files or descriptions of the images and voice system prompts as text for prompts given to telephone users as the system is used.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. A method, comprising:
allowing a user to designate a telephone number of a text enabled telephone;
transmitting a text message to the text enabled telephone with the text message comprising a callback telephone number of the user; and
receiving a callback telephone call from a communication network and presenting the callback telephone call to the user at a computer.

2. A method as recited in claim 1, wherein the message is a multimedia message.

3. A method as recited in claim 1, wherein the communication network is a public switched telephone network.

4. A method as recited in claim 1, wherein the communication network is a VoIP network.

5. A method as recited in claim 1, wherein the computer comprises a computer assisted telephone application.

6. A method as recited in claim 1, wherein the computer comprises a personal digital assistant.

7. A method as recited in claim 1, wherein the computer comprises a computer assisted telephone application.

8. A method as recited in claim 1, wherein the message comprises a personal message from the user.

9. A method as recited in claim 1, wherein the message comprises the users telephone number.

10. A method as recited in claim 1, wherein the call back number comprises the users telephone number for offline message origination.

11. A method as recited in claim 1, further comprising providing the message delivery status to the user.

12. A method as recited in claim 1, further comprising allowing the message receiver to activate a send button to call the user.

13. A method as recited in claim 1, further comprising sending the call back to a voice message system when the user does not accept the call back call or the user is online.

14. A method, comprising:
allowing a user to designate a telephone number of a multimedia enabled telephone;
transmitting a multimedia message to the multimedia enabled telephone with the multimedia message comprising a callback telephone number of the user and a personal message from the user;
providing the message delivery status to the user;
allowing the message receiver to activate a send button to call the user;
transmitting a callback telephone call over a public switched telephone network; and
presenting the callback telephone call to the user at a personal computer responsive to the send activation.

15. An interface, comprising:
a telephone number field for a cellular telephone to which to send a call back text message; and
a control to send the callback message to the cellular telephone number.

16. An interface as recited in claim 15, further comprising a personal message field for a user to specify a personal message to an owner of the cellular telephone.

17. An interface as recited in claim 15, further comprising a message field to specify a call back telephone number.

18. An interface as recited in claim 15, wherein the message comprises a multimedia message.
